(19) United States
(12) Patent Application Publication
(10) Pub. No.: US 2017/0349035 A1
(43) Pub. Date: Dec. 7, 2017

(54) PROTECTIVE DEVICE FOR A VEHICLE INTERIOR AND REAR SHELF FOR AN INTERIOR OF A PASSENGER CAR

(71) Applicant: BOS GMBH & CO. KG, Ostfildern (DE)

(72) Inventors: Huan TRAN, Ostfildern (DE); Matthias MAIER, Esslingen (DE)

(21) Appl. No.: 15/536,005

(22) PCT Filed: Nov. 11, 2015
(86) PCT No.: PCT/EP2015/076296

§ 371 Date: Jun. 29, 2017

(30) Foreign Application Priority Data
Dec. 15, 2014 (DE) 10 2014 225 896.0

(51) Int. Cl. B60J 1/20

(52) U.S. Cl. CPC B60J 1/2025; B60J 1/2063; B60J 1/208

(57) ABSTRACT

Protective device for a vehicle interior compartment and rear shelf for a passenger vehicle including a flexible planar structure which is held on a roller blind shaft to be wound up and off between a pulled-out protective position and a compactly stored rest position. The planar structure is connected to a pull-out profile, which pull-out profile is guided on each of its opposite sides in a respective guiding structure for longitudinal displacement between the rest position and the protective position of the planar structure. A drive device is provided for displacement of the pull-out profile, which includes an electric motor and drive transmission extending alongside the guiding structures and operatively connected to the pull-out profile. The roller blind shaft is rotatably mounted, without a winding spring, on opposite face ends in two casing arrangements. The drive transmission includes a cable pull, and a casing arrangement on the drive side is provided with a holder device for the electric motor coupled to both the roller blind shaft and the cable pull via a torque transmission arrangement associated with the casing arrangement on the drive side.

The invention relates to a protection device for a vehicle interior compartment, comprising a flexible planar structure which is held on a roller blind shaft to be wound up and off between a pulled-out protective position and a compactly stored rest position, wherein the planar structure is connected to a dimensionally stable pull-out profile on a face end region that is in front in the pull-out direction, which pull-out profile is guided on each of its opposite sides in a respective guiding structure disposed fixed to the vehicle interior in the ready-for-use condition for longitudinal displacement between the rest position and the protective position of the planar structure, and comprising a drive device for displacement of the pull-out profile, which includes an electric motor and drive transmission means extending alongside the guiding structures and operatively connected to the pull-out profile.

The invention also relates to a rear shelf for an interior compartment of a passenger vehicle, comprising means for retaining a protection device for shading a rear window, in particular in the form of a protection device as described above.

A protection device for a vehicle interior compartment in the form of a shading device for a rear window of a passenger vehicle is disclosed in EP 1 215 063 A1. The known shading device includes a flexible planar structure which is held on a roller blind shaft to be wound up and off. The roller blind shaft is rotatably mounted to the vehicle and comprises a winding spring which exerts a permanent torque on the roller blind shaft in the winding-up direction of the planar structure. The planar structure includes a dimensionally stable pull-out profile on a face end region that is in front in the pull-out direction, which pull-out profile is guided for longitudinal displacement in vehicle-fixed lateral guiding rails. For guiding the pull-out profile, drive transmission means in the form of flexshafts which are driven by an electric motor via a gear mechanism are provided in the region of the opposite guiding rails. In the pull-out direction, the electric motor has to drive the drive transmission means counter the return torque of the winding spring of the roller blind shaft acting on the planar structure and the pull-out profile. The electric motor is disposed spaced from the roller blind shaft and fixed to the vehicle. The roller blind shaft is rotatably mounted below a one-piece rear shelf and fixed to the vehicle. In the rear shelf a passage slot is provided, through and across which slot the planar structure can go out above the rear shelf and be pulled out along the rear window.

An object of the invention is to provide a protection device and a rear shelf of the above mentioned type, which allow a compact structural design and can be assembled and operated in a cost-efficient manner.

The object is achieved for the protection device in that the roller blind shaft is rotatably mounted, without a winding spring, on opposite face ends in two casing arrangements, in that the drive transmission means comprise at least one cable pull, and in that a casing arrangement on the drive side is provided with a holder device for the electric motor which is coupled to both the roller blind shaft and the at least one cable pull via torque transmission means associated with the casing arrangement on the drive side. The solution according to the invention is with particular advantage provided for protection devices which are employed for shading of rear window or side window panes of passenger vehicles. As an alternative, the protection device according to the invention can also be employed for shading of transparent roof portions of vehicle interiors of passenger vehicles. The protection device according to the invention also comprises use as a loading compartment covering and/or partitioning device, in order to achieve approximately horizontal covering of the loading compartment and/or approximately vertical partitioning from a vehicle interior. Thus, the protection device according to the invention is provided as a shading device, as a loading compartment covering device or as a loading compartment partitioning device.

Owing to the feature that the electric motor drives both the roller blind shaft and the pull-out profile, the roller blind shaft as such can do without an additional torque application by a winding spring. As a result, the roller blind shaft is mounted for free rotation. Therefore, the electric motor does not have to counteract a return force of a winding spring and can be embodied with correspondingly lesser power output. The arrangement of the holder device for the electric motor directly on one of the two casing arrangements allows a particularly compact structural design of the protection device. Moreover, the protection device together with the drive device thereof can be provided in a pre-assembled state, whereby a considerably facilitated final assembly in the vehicle is achieved. Providing at least one cable pull, allows a particularly low-friction layout of the drive transmission means, whereby the needed drive energy for the electric motor can be further reduced. The casing arrangements, which provide rotatable bearing of the roller blind shaft on opposite face ends, are disposed fixed to the vehicle in the ready-for-use assembled condition.

In an embodiment of the invention, the casing arrangements are fastened on opposite face ends of an accommodation profile mounted fixed to the vehicle in the ready-for-use condition. The accommodation profile is preferably designed as a cartridge-type hollow profile which is connected to a support structure part on the vehicle interior side in the ready-for-use condition. If the protection device is employed for shading a rear window of a passenger vehicle, a rear shelf is provided as support structure part on the vehicle interior side. The cartridge-type hollow profile and the opposite lateral casing arrangements together form a cartridge housing. As an alternative, the accommodation profile is designed as an accommodation trench integrally molded in the support structure part. In an embodiment of the protection device as a shading device for a rear window of a passenger vehicle, the accommodation trench is, consequently, integrally molded in the rear shelf. Thereby, a reduction in structural components and an advantageous pre-assembly of the protection device on the rear shelf is possible.

In a further embodiment of the invention, the support structure part includes a covering portion to cover the accommodation trench while leaving a passage slot for the flexible planar structure. Advantageously, the support structure part and the covering portion together constitute a two-part rear shelf for a passenger vehicle. This embodiment is adapted to use for employment of the protection device according to the invention as a shading device for a rear window of a passenger vehicle. Advantageously, the accommodation trench is integral to a front-sided rear shelf portion of the two-part rear shelf. In a back-sided rear shelf portion of the two-part rear shelf, a third stop light can be provided. The back-sided rear shelf portion is utile as a covering portion, in order to cover the accommodation trench while leaving the passage slot for the flexible planar structure.

In a further embodiment of the invention, the casing arrangements each include plug-in portions facing the accommodation profile and matched to face edge regions of the accommodation profile in such a way that the lateral casing arrangements can be plugged onto the face edge regions of the accommodation profile. The casing arrangements are preferably made of synthetic material and subsequently plugged onto the face edge regions of the accommodation profile. Located there, they can additionally be fixed if the plug-in connection alone does not allow sufficient fixation. If the accommodation profile is designed as an accommodation trench of a rear shelf, the casing arrangements are connected to the rear shelf in a simple manner. If in an alternative the accommodation profile is designed as a cartridge-type hollow profile, the lateral casing arrangements, upon plugging onto the hollow profile, together with the hollow profile form a cartridge housing as a bearing for the roller blind shaft.

In a further embodiment of the invention, the lateral guiding structures are connected to the casing arrangements bearing the roller blind shaft. Preferably, the lateral guiding structures are provided with guiding tracks for guiding the pull-out profile and for installing a respective cable pull. Advantageously, the lateral guiding structures are made of synthetic material. The lateral guiding structures can be integrally molded to the casing arrangements.

In a further embodiment of the invention, the electric motor is fixed transversely in relation to a rotational axis of the roller blind shaft to the casing arrangement on the drive side. The torque transmission means are to establish a drive coupling between electric motor and roller blind shaft. Preferably, a toothed gear mechanism is provided in order to cause torque transmission between electric motor and roller blind shaft.

In a further embodiment of the invention, the roller blind shaft is coupled in a torque transmitting manner to a further cable pull via torque transmission means on the driven side opposite the casing arrangement on the drive side, which further cable pull is associated with a guiding structure on the driven side for displacement of the pull-out profile. In this embodiment, the pull-out profile is accordingly driven on opposite sides by drive transmission means of identical design, wherein the roller blind shaft is a synchronization shaft and drive transmission means for the drive force of the electric motor from the drive side to the driven side. As a result, a closed drive system is obtained in connection with the flexible planar structure which is connected to the pull-out profile and the roller blind shaft.

In a further embodiment of the invention, each cable pull includes a respective cable drum associated with the casing arrangements on the drive side and the driven side, respectively, which are disposed coaxial in relation to the roller blind shaft and for torque transmission. The cable drums for the drive side and the driven side are part of the respective cable pull.

In a further embodiment of the invention, a cable pull compensation unit is disposed between each cable drum and the roller blind shaft to readjust different loadings depending on different winding layers of the planar structure. The cable pull compensation unit is used to compensate cable elongations or cable pull force differences, occurring during operation of the protection device, in particular due to different cable looping lengths in the region of the cable drum. The cable pull compensation unit is advantageously a torsion spring which can be a helically wound leg spring.

In a further embodiment of the invention, the two cable pulls are configured as open cable pulls. What is meant thereby is that an open cable is held with one cable end on a respective cable drum for winding up and off, and with the other cable end is in operative connection to the pull-out profile. Regardless of the configuration of the cable pulls as open cable pulls, there is in total a closed system obtained for the drive system of the protection device, as already explained above.

In a further embodiment of the invention, the roller blind shaft is coupled on the drive side and the driven side to the respective cable drum via a respective elastic coupling member for torque transmission. The elastic coupling member is used to readjust angular tolerances, radial offset and axial offset tolerances between a rotational axis of the winding shaft and rotational axes of the cable drums or the toothed gear mechanism of the electric motor, which are mounted to the casing arrangements. Moreover, an improved damping is obtained, resulting in advantages in noise emission.

In a further embodiment of the invention, the elastic coupling member is part of an elastic plug-in coupling which is capable of readjusting radial, axial and angular tolerances between the rotational axis of the roller blind shaft and torque transmission means on the drive or driven sides. The plug-in coupling is easy to assemble. Advantageously, the roller blind shaft is connected, on its opposite face ends, to the respective parts both on the drive side and on the driven side of the drive system of the protection device via a respective plug-in coupling, in order to allow readjusting of corresponding tolerances. Owing to the elastic coupling member, there is also a smooth torque transmission characteristic curve between the drive system parts on the drive side and the roller blind shaft and the roller blind shaft, and the drive system parts on the driven side. The drive system of the protection device according to the invention comprises in addition to the electric motor preferably the toothed gear mechanism for torque transmission to the cable drum on the drive side and the roller blind shaft, to the cable pulls and to the cable pull compensation units in connection with corresponding sliding blocks in the guiding structures which are coupled to the pull-out profile.

In a further embodiment of the invention, the cable pull compensation unit includes a torsion spring which is axially integral to the cable drum. This feature allows a particularly low space occupying accommodation of the torsion spring, whereby a compact structural design of the protection device is further improved.

For the rear shelf of the above mentioned type, the object of the invention is achieved in that the rear shelf is a two-part device comprising a front-sided and a back-sided rear shelf portion, in that the front-sided rear shelf portion includes an accommodation profile open towards the top, integrally molded-in and extending continuously over a width of the rear shelf portion, which accommodation profile is provided for accommodating a roller blind shaft on which a flexible shading structure is held for winding up and off, and in that the back-sided rear shelf portion is arranged in relation to the front-sided rear shelf portion in such a manner that the back-sided rear shelf portion is disposed relative to the front-sided rear shelf portion such that the rear-sided rear shelf portion covers the accommodation profile while leaving a passage slot for the shading device. Thereby, a protection device for shading a rear window of a passenger vehicle can be pre-assembled to the rear shelf in a simple manner. Owing to the one-piece integration of the trench-shaped accommodation profile in the front-sided rear shelf portion, a reduction in components for the protection device is possible. Moreover, there is facilitated pre-assembly of the protection device to the rear shelf. Owing to the two-part configuration of the rear shelf, there is no need for a passage slot to be provided in the rear shelf, in contrast to the case with the prior art.

Further advantages and features of the invention will become apparent from the claims and the description given below of preferred exemplary embodiments of the invention illustrated with reference to the drawings.

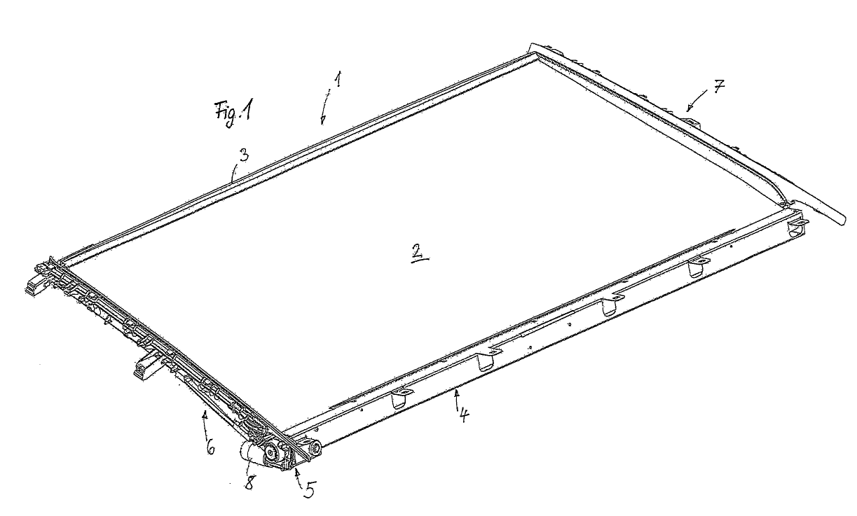

FIG. 1 shows a perspective view of an embodiment of a protection device according to the invention in the form of a shading device for a rear window of a passenger vehicle;

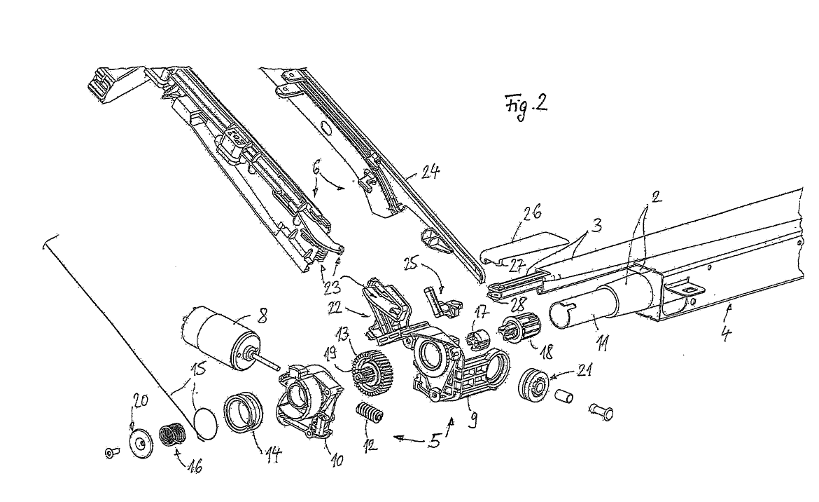

FIG. 2 shows an exploded view of a drive side of the shading device according to FIG. 1;

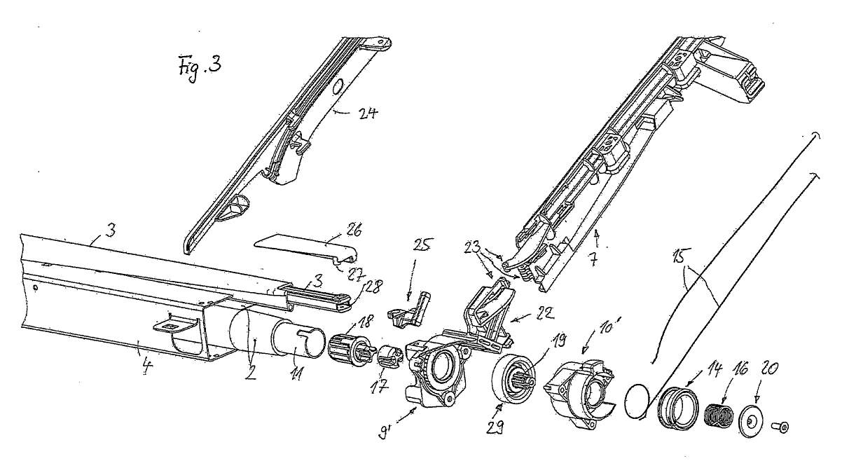

FIG. 3 shows an exploded view of a driven side of the shading device according to FIG. 1;

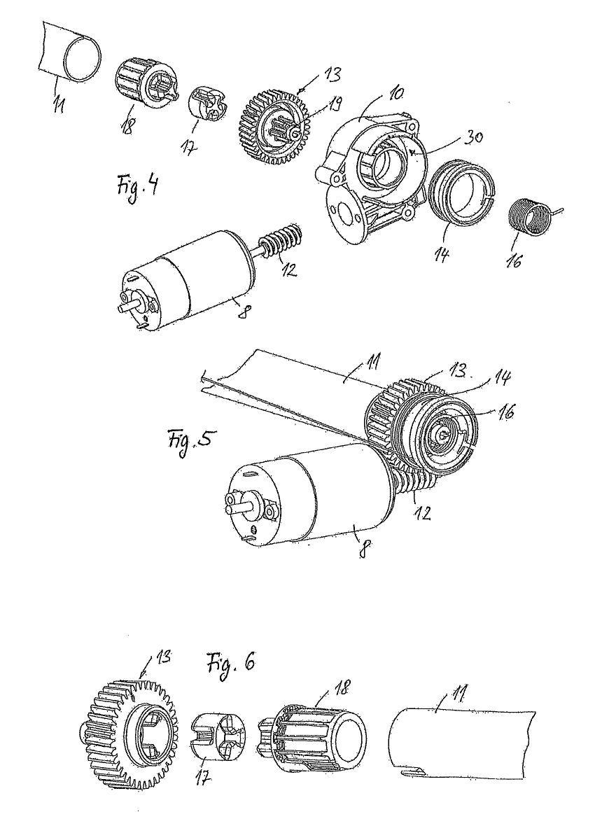

FIG. 4 shows an exploded view of torque transmission on the drive side between an electric motor and a roller blind shaft;

FIG. 5 shows the torque transmission according to FIG. 4 in the assembled condition;

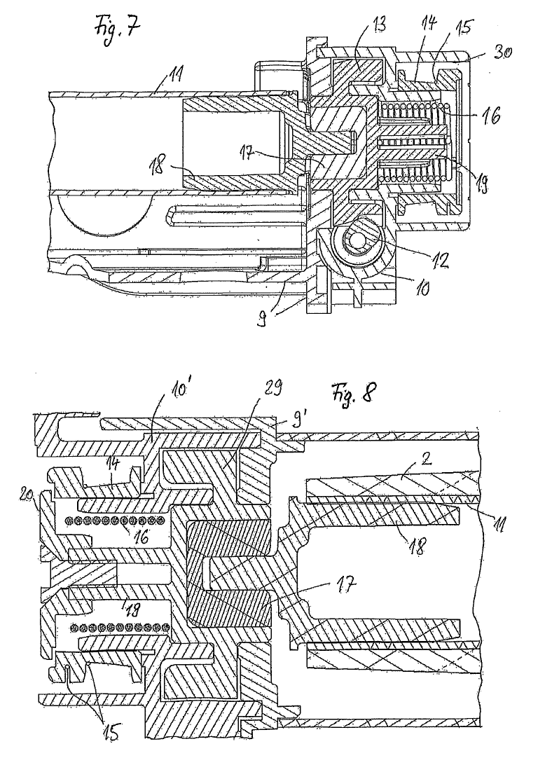

FIG. 6 shows an exploded view of an elastic plug-in coupling between roller blind shaft and drive gear according to FIGS. 4 and 5;

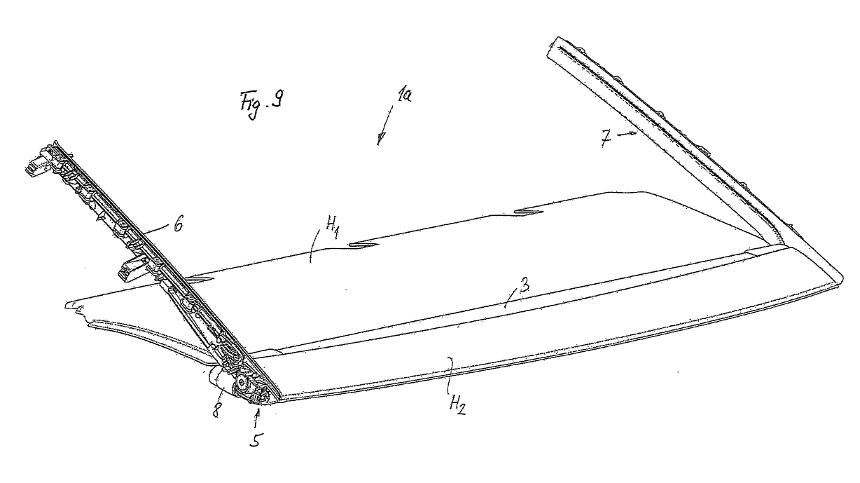

FIG. 7 shows a sectional view of a part of the shading device in the region of a casing arrangement on the drive side for bearing the roller blind shaft;

FIG. 8 shows an enlarged sectional view of a part of the shading device according to FIGS. 1 to 6 the region of a casing arrangement on the driven side;

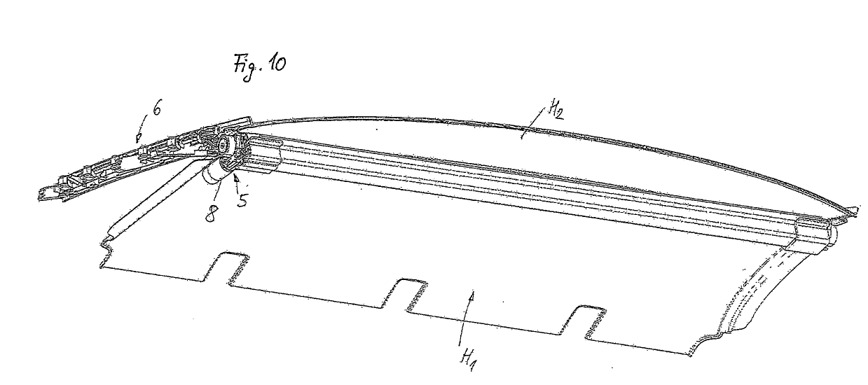

FIG. 9 shows a perspective view of another embodiment of a protection device according to the invention in the form of a shading device for a rear window of a passenger vehicle;

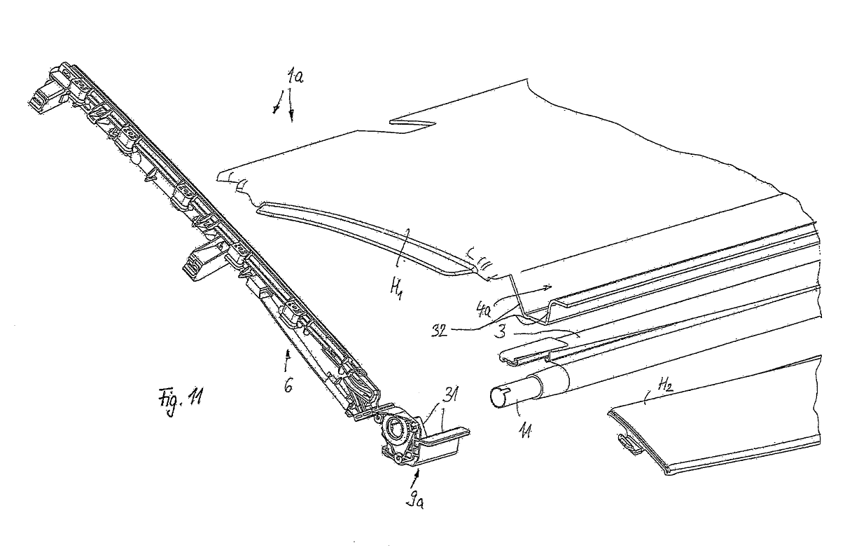

FIG. 10 shows a perspective view of the shading device according to FIG. 9 obliquely from below;

FIG. 11 shows an enlarged exploded view of a left-hand side of the shading device; and

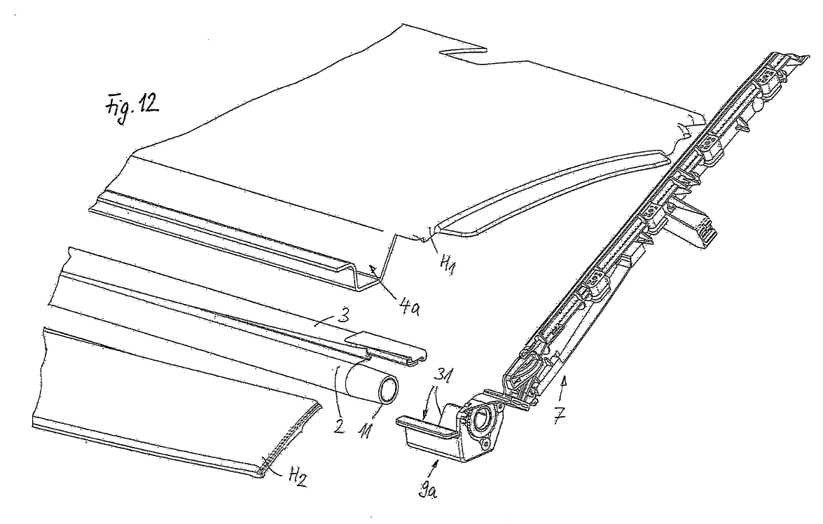

FIG. 12 shows an exploded view of a right-hand side of the shading device according to FIGS. 9 and 10.

A protection device in the form of a shading device 1 according to FIGS. 1 to 8 is provided for shading a rear window of a passenger vehicle. The shading device 1 comprises a flexible planar structure 2, in the present case in the form of a textile knitted or woven fabric, which is held on a roller blind shaft 11 to be wound up and off between a pulled-out protective position, shown in FIG. 1, and a wound-up rest position, shown in FIG. 2. The roller blind shaft 11 is designed as a cylindrical hollow profile. The planar structure 2 and the winding shaft 11 are enclosed by a dimensionally stable, cartridge-type accommodation profile 4 over a major part of their longitudinal extension as seen in the longitudinal direction of the roller blind shaft 11.

In a ready-for-use functional condition assembled to the vehicle, the roller blind shaft is disposed below a rear shelf (not illustrated) which is positioned in the vehicle interior below the rear window of the passenger vehicle. A passage slot is provided in the rear shelf, through and across which slot the flexible planar structure 2 extends.

The flexible planar structure 2 is connected to a dimensionally stable pull-out profile 3 on its face end region that is in front in the pull-out direction.

It is apparent with reference to FIGS. 2 and 3 that, for this purpose, the planar structure 2 is provided with a welting in the front face end region thereof, which welting is inserted in a complementary welting groove of the pull-out profile 3 along the pull-out profile 3. In a wound-up rest position of the planar structure 2 the pull-out profile 3 is located in the region of an upper side of an edge of the passage slot resting on the rear shelf and covering the passage slot.

It is apparent with reference to FIGS. 1 to 3 that the roller blind shaft 11 is mounted on its opposite face ends in two casing arrangements 5, 9, 10; 9′, 10′, which will be described in more detail below, wherein, in the illustration according to FIG. 1, the left-hand side casing arrangement 5 represents a casing arrangement on the drive side and, in the illustration according to FIG. 3, the right-hand side casing 9′, 10′ represents a casing arrangement on the driven side. The two casing arrangements 5, 9, 10; 9′, 10′ are each connected to the cartridge-type accommodation profile 4 on a respective face end side thereof. For that purpose, casing shell parts 9, 9′ of the casing arrangements include plug-in profilings (not illustrated in more detail) to be plugged-in on the respective open face end side of the cartridge-type accommodation profile 4 in an accurately fitting manner. In addition, mechanical fixation elements, like screw or rivet connections, are provided (not illustrated in more detail), in order to secure the respective casing shell part 9, 9′ on the accommodation profile 4 in the plugged-on condition.

The two casing arrangements 5, 9, 10; 9′, 10′ are made of synthetic material and include integrally molded bearing and accommodation portions for further functional components, which will be described in more detail below.

The casing arrangement 5 on the drive side includes, in addition to the casing shell part 9 to be connected to the accommodation profile 4, a casing portion 10, adapted to be joined to the casing shell part 9 by means of screw connections or similar mechanical fixation means. The casing portion 10 has a holding recess (not illustrated in more detail) for fixation of an electric motor 8 which drives the roller blind shaft 11 in a manner that will be described in more detail below. A worm wheel 12, also referred to as a worm, is fixed to a drive shaft of the electric motor 8, which worm meshes with a toothed gear wheel 13 which is arranged coaxially in relation to a rotational axis of the roller blind shaft 11 and connected to the roller blind shaft 11 for conjoint rotation. The gear wheel 13 is embodied as a toothed spur gear wheel. The electric motor 8 is fixed to the casing portion 10 transversely in relation to the rotational axis of the roller blind shaft 11. The worm wheel 12 is positioned below the gear wheel 13 meshing in relation to the gear wheel 13, as is apparent with reference to FIGS. 4 and 5.

Torque transmission between the electric motor 8 and the roller blind shaft 11 occurs from the gear wheel 13 via an elastic plug-in coupling device 17, 18, clearly apparent with reference to FIGS. 4 and 6. The elastic plug-in coupling device includes an elastic coupling member 17 which is a one-piece elastomer body including corresponding, axially open plug-in profilings both towards the gear wheel 13 and towards a face end-sided terminal body 18. The face end-sided terminal body 18 is a face end-sided cover or closure for the roller blind shaft 11 and includes complementary, on the face end side axially outwards protruding plug-in profilings which plunge into the plug-in profilings of the elastic coupling member 17 for conjoint rotation. The gear wheel 13 includes, as is apparent with reference to FIG. 6, plug-in profilings axially extending towards the roller blind shaft 11 (not illustrated in more detail), which plunge into the plug-in profilings, configured as axial recesses, of the elastic coupling member 17 in a claw-type manner. Additionally, the gear wheel 13 is provided with a cylindrical ring flange, wherein the axial plug-in profilings are provided on the inner side thereof. The ring flange receives the coupling member 17 axially, as visible in FIG. 7. The connection between the gear wheel 13, the coupling member 17 and the face end-sided terminal body 18 is obtained by simple axial plugging-in of said functional parts. The gear wheel 13 is rotatably mounted in a bearing seat (not illustrated in more detail) of the casing arrangement 5, 9, 10.

The casing arrangement 5, 9, 10 is fixed to the accommodation profile 4 using vibration damping elements 21, merely one thereof illustrated in FIG. 2.

The electric motor 8 drives the roller blind shaft 11 about its rotational axis in both directions of rotation via the torque transmission means in the form of the worm wheel 12, the gear wheel 13, the axial plug-in profilings, the elastic coupling member 17 and the face end-sided terminal body 18.

On an opposite face end the roller blind shaft 11 is provided with further torque transmission means which are in a mirror symmetrical manner likewise embodied by an elastic plug-in coupling device having a face end-sided terminal body 18, an elastic coupling member 17 and the axial plug-in profilings (not illustrated in more detail) of a support disk 29. All of the functional parts or portions of said opposite driven side of the roller blind shaft 11, indicated by the same reference numerals, have an identical design as compared to the corresponding functional parts of the above described drive side according to FIG. 2. Thus, to avoid repetitions, additional reference is made to the disclosure in relation the drive side functional parts.

It is apparent with reference to FIGS. 3 and 8 that the roller blind shaft 11 on the driven side is coupled to the support disk 29 for conjoint rotation for the sole reason that driving of a cable pull system on this driven side is ensured. An identical cable pull system is also associated with the drive side and will be described in more detail below. The support disk 29 is rotatably mounted between the casing shell part 9′ and the casing portion 10′, wherein the casing portion 10′ is connected to the casing shell part 9′ by means of screw connections or similar mechanical fixation means.

Both the casing portion 10 and the casing portion 10′ include a cylindrical annular shoulder protruding axially outwards relative to the roller blind shaft 11, with a respective cable drum 14 rotatably mounted on each thereof. Moreover, each casing portion includes a covering shield in the shape of a cylinder section enclosing the cable drum 14 over a major part of its circumference radially on the outside, which covering shield encloses the cable drum 14 radially on the outside in the circumferential direction. As a result, there is an annular space 30 (FIG. 4) produced between the covering shield and the inner-sided annular shoulder, wherein the cable drum 14 is rotatably mounted. The respective cable drum 14 is mounted for free rotation in the respective casing arrangement 5, 9, 10; 9′, 10′. Coupling of the respective cable drum 14 to the roller blind shaft 11 is obtained by interposing a torsion spring 16 acting as a cable length compensation unit, which is embodied in a helical leg spring. One leg end of the torsion spring 16 is connected to the cable drum 14 for conjoint rotation. An opposite leg end of the helical torsion spring 16 is connected to a support ring 19 of the gear wheel 13 and the support disk 29, respectively, for conjoint rotation. The respective support ring 19 is integrally molded to the gear wheel 13 and the support disk 29, respectively. Using an axial lock washer 20 and a screw (not illustrated in more detail), the respective torsion spring 16 is axially fixed to the support ring 19 of the gear wheel 13 and the support disk 29, respectively.

On each cable drum 14 is held a respective cable end of a respective open cable 15. The cable end is fixed to a corresponding holder on an outer circumference of the respective cable drum 14 such that the cable cannot disengage from the cable drum 14 during operation of the shading device.

Each casing shell part 9, 9′ includes an integrally molded tab 22 for pivotable retaining of a guiding structure 6, 7. Said guiding structures 6 and 7 are fixed to the vehicle in the completely assembled, ready-for-use condition of the shading device 1, 1a. The vehicle-related fixation is along the C-pillar portions of a vehicle body support structure of the passenger vehicle. Each guiding structure 6, 7 has a two-part design and includes a respective outer side functional profile and an inner side lining cover 24, as seen relative to a center of the vehicle interior, which are matched to corresponding lining parts of the vehicle interior. The lining cover 24 and the functional profile are joined together after completed assembly of the respective functional profile to the vehicle. The two functional profiles of the opposite lateral guiding structures 6, 7 are mirror symmetrical, however, for the rest have an identical design. Each functional profile is pivotably connected to the tab 22 of the casing shell part 9 via a respective hinge arrangement 23. The hinge arrangement 23 comprises hinge profilings and guiding and travel limiting means, each integrally molded to the functional profile or the tab 22. The functional profiles—like the casing shell parts 9—are one-piece components each made of a thermoplastic synthetic material.

The two guiding structures 6, 7 are used for longitudinal displacement of the pull-out profile 3. For that purpose, the pull-out profile 3 is provided with a respective seat 28 for retaining a sliding body 25 on each of its opposite face ends. The pull-out profile 3 has a telescopic design such that the retaining seats 28 are provided on lateral parts of the pull-out profile 3, which are lengthwise displaceable relative to a dimensionally stable central part of the pull-out profile 3 in the transverse direction of the vehicle and, thus, transversely to a pull-out direction of the planar structure 2, so that the pull-out profile 3 is telescopically operable. The sliding body 25 has an accommodation eye (not illustrated in more detail) which is inserted into the retaining seat 28. Fixing of the sliding body 25 to the face end of the pull-out profile 3 is by a socket pin 27 of a cover part 26 of the pull-out profile 3.

The sliding body 25 comprises an elongate sliding block which is guided for longitudinal shifting in a guiding groove serving as a guiding track (not illustrated in more detail) of the respective functional profile of both the guiding structures 6, 7. In the respective functional profile, the cable 15 of the cable pull is guided in a distinct guiding track, deflected by 180° on a face end region of the respective functional profile remote from the tab 22 and the hinge arrangement 23, and guided through the guiding groove for the sliding body 25 up to the sliding block of the sliding body 25. A free cable end of the cable 15 is fixed to the sliding block of the sliding body 25. This description applies both to the drive side and to the driven side. Thus, an entire closed drive system is obtained.

Pivoting mobility of the functional profile relative to the tab 22 and the respective casing shell part 9, 9′ is available only prior to and during an assembling procedure of the shading device in the passenger vehicle. After assembly of the respective functional profile fixed to the vehicle on vehicle-related body support structure regions, in particular in the region of C-pillar portions, the respective functional profile is fixed to the vehicle so that pivoting mobility is no longer available. After completed ready-for-use assembly of the shading device 1 in the vehicle interior, driving of the electric motor 8 causes rotation of the roller blind shaft 11 and simultaneous and synchronous rotation of both cable drums 14 of the cable pulls on the drive side and the driven side, whereby the sliding bodies 25 are displaced in synchronization lengthwise the guiding grooves of the opposite functional profiles. Thereby, the pull-out profile 3 can be displaced between the wound-up rest position of the planar structure 2 and the pulled-out protective position of the planar structure 2, as needed. The torsion springs 16 in the opposite sides of the drive system are for cable length compensation in response to different positions of the planar structure, i.e. the different winding layers. Thereby, a uniform fabric tension and, as a result, wrinkle-free pulling out and pulling in of the planar structure is achieved. Thereby, a closed and self-adjusting drive system is obtained. The electric motor 8 can be designed with a very low performance, since owing to the absence of a winding spring, which would be associated with the roller blind shaft 11, there is no need for great driving forces. Moreover, driving forces of approximately equal amount are needed for deploying of the pull-out profile 3 from the rest position to the protective position and for retracting the pull-out profile 3 from the protective position to the rest position.

In the embodiment according to FIGS. 9 to 12, the shading device 1a includes guiding structures 6, 7 and a closed drive system including corresponding cable pulls which have an identical design as compared to the above described embodiment. Thus, to avoid repetitions, in relation to the shading device 1a according to FIGS. 9 to 12, exclusively the differences of said embodiment are discussed.

An essential difference of the shading device 1a is in that the roller blind shaft 11 and the wound-up planar structure 2 together extend lengthwise in an accommodation profile 4a which is an integral part of a front-sided rear shelf portion H₁. The accommodation profile 4a is constituted by an integrally molded trench-type recess extending over the entire width of the rear shelf portion H₁. The thereby formed accommodation profile 4a is open both towards the top and towards opposite face end sides thereof. On its opposite face end sides, the accommodation profile 4a is provided with spur wheels 32 and plug-in profilings 31 of complementary design on a respective casing shell part 9a can be plugged thereon. The corresponding casing shell part 9a is a respective inner-sided part of a casing arrangement on a drive side and a driven side, respectively, which have a similar functional design as the casing arrangements described above with reference to the FIGS. 1 to 8. The casing shell parts 9a are fixed to the rear shelf portion H₁ upon plugging onto the accommodation profile 4a of the rear shelf portion H₁ using appropriate fixation means.

The front-sided rear shelf portion H₁ extends—as seen in the ordinary driving direction of the passenger vehicle—in front of a back-sided rear shelf portion H₂ which covers the accommodation profile 4a on the top side in the completely assembled, ready-for-use operative condition. Thereby, the back-sided rear shelf portion H₂ leaves a longitudinal slot in the region of the accommodation profile 4a, which slot is provided to allow passage of the planar structure 2 from the accommodation profile 4a upwards. The longitudinal slot is constituted by a front-sided edge of the rear shelf portion H₂ and a front-sided edge of the accommodation profile 4a on the rear shelf portion H₁. The longitudinal slot is sufficiently wide that the planar structure 2 can pass through. Also, the longitudinal slot is sufficiently narrow that the pull-out profile 3 comes to abut on an upper-sided edge of the longitudinal slot in the rest position of the planar structure 2 (FIG. 9) such that the pull-out profile 3 covers the remaining open longitudinal slot towards the accommodation profile 4a in the rest position of the planar structure.

1. Protection device for a vehicle interior compartment, comprising a flexible planar structure which is held on a roller blind shaft to be wound up and off between a pulled-out protective position and a compactly stored rest position, wherein the planar structure is connected to a dimensionally stable pull-out profile on a face end region that is in front in the pull-out direction, which pull-out profile is guided on each of its opposite sides in a respective guiding structure disposed fixed to the vehicle interior in the ready-for-use functional condition for longitudinal displacement between the rest position and the protective position of the planar structure, and comprising a drive device for displacement of the pull-out profile, which includes an electric motor and drive transmission means extending alongside the guiding structures and operatively connected to the pull-out profile, wherein the roller blind shaft is rotatably mounted, without a winding spring, on opposite face ends in two casing arrangements, in that the drive transmission means comprise at least one cable pull, and in that a casing arrangement on the drive side is provided with a holder device for the electric motor which is coupled to both the roller blind shaft and the at least one cable pull via torque transmission means associated with the casing arrangement on the drive side.

2. Protection device according to claim 1, wherein the casing arrangements are fastened on opposite face ends of an accommodation profile mounted fixed to the vehicle in the ready-for-use functional condition.

3. Protection device according to claim 2, wherein the accommodation profile is designed as a cartridge-type hollow profile which is connected to a support structure part on the vehicle interior side in the ready-for-use functional condition.

4. Protection device according to claim 2, wherein the accommodation profile is designed as an accommodation trench integrally molded in the support structure part.

5. Protection device according to claim 4, wherein the support structure part includes a covering portion to cover the accommodation trench while leaving a passage slot for the flexible planar structure.

6. Protection device according to claim 4, wherein the support structure part and the covering portion together constitute a two-part rear shelf for a passenger vehicle.

7. Protection device according to claim 1, wherein the casing arrangements each include plug-in portions facing the accommodation profile and matched to face edge regions of the accommodation profile in such a way that the lateral casing arrangements can be plugged onto the face edge regions of the accommodation profile.

8. Protection device according to claim 1, wherein the lateral guiding structures are connected to the casing arrangements bearing the roller blind shaft.

9. Protection device according to claim 1, wherein the electric motor is fixed transversely in relation to a rotational axis of the roller blind shaft to the casing arrangement on the drive side.

10. Protection device according to claim 1, wherein the roller blind shaft is coupled in a torque transmitting manner to a further cable pull via torque transmission means on the driven side opposite the casing arrangement on the drive side, which further cable pull is associated with a guiding structure on the driven side for displacement of the pull-out profile.

11. Protection device according to claim 10, wherein each cable pull includes a corresponding cable drum associated with the casing arrangements on the drive side and the driven side, respectively, which are disposed coaxial in relation to the roller blind shaft and for conjoint rotation.

12. Protection device according to claim 10, wherein a cable pull compensation unit is disposed between each cable drum and the roller blind shaft to readjust different loadings depending on different winding layers of the planar structure.

13. Protection device according to claim 10, wherein the two cable pulls are configured as open cable pulls.

14. Protection device according to claim 1, wherein the roller blind shaft is coupled to the respective cable drum via a respective elastic coupling member for torque transmission.

15. Protection device according to claim 14, wherein the elastic coupling member is part of an elastic plug-in coupling which is capable of readjusting radial, axial and angular tolerances between the rotational axis of the roller blind shaft and torque transmission means on the drive or driven sides.

16. Protection device according to claim 12, wherein the cable pull compensation unit comprises a torsion spring which is axially integral to the cable drum.

17. Rear shelf for an interior compartment of a passenger vehicle, comprising means for retaining a protection device for shading a rear window, in particular in the form of a protection device according to claim 1, wherein the rear shelf is a two-part device composed of a front-sided and a back-sided rear shelf portion, in that the front-sided rear shelf portion includes an accommodation profile open towards the top, integrally molded-in and extending continuously over a width of the rear shelf portion, which accommodation profile is provided for accommodating a roller blind shaft on which a flexible shading structure is held for winding up and off, and in that the back-sided rear shelf portion is arranged in relation to the front-sided rear shelf portion in such a manner that the back-sided rear shelf portion covers the accommodation profile while leaving a passage slot for the shading device.
